(19) United States
(12) Patent Application Publication
(10) Pub. No.: US 2022/0390642 A1
(43) Pub. Date: Dec. 8, 2022

(54) BATTERY-POWERED VEHICLE DETECTING DEVICE USING AN EMBEDDED INDUCTIVE SENSOR

(71) Applicant: Nwave Technologies Inc, Sacramento, CA (US)

(72) Inventor: Yury BIRCHENKO, Sacramento, CA (US)

(21) Appl. No.: 17/752,406

(22) Filed: May 24, 2022

Related U.S. Application Data
(60) Provisional application No. 63/196,085, filed on Jun. 2, 2021.

(51) Int. Cl. G01V 3/10; G08G 1/042

(52) U.S. Cl. CPC G01V 3/10; G08G 1/042; G08G 1/14

(57) ABSTRACT

Various embodiments set forth a device comprising a battery that generates a first power, and an inductive sensor that generates a magnetic field based on the first power, and generates, based on a change to the magnetic field, a sensing signal indicating a presence of an object, where delivery of the first power to the inductive sensor is based on one or more additional signals.

### CROSS-REFERENCE TO RELATED APPLICATIONS

This application claims the priority benefit of U.S. Provisional Patent Application titled, “BATTERY-POWERED VEHICLE DETECTION DEVICE USING AN EMBEDDED INDUCTIVE SENSOR,” filed on Jun. 2, 2021, having Application Serial No. 63/196,085. The subject matter of this related application is hereby incorporated herein by reference in its entirety.

### BACKGROUND

### Field Of The Various Embodiments

Embodiments disclosed herein generally relate to the vehicle sensors, and more specifically, a battery-powered vehicle-detection device using an embedded inductive sensor.

### Description Of The Related Art

A battery-powered vehicle-detection device that detects the presence of a motor vehicle is typically relatively small, easy to carry, and easy to install. These devices are oftentimes used to monitor parking spaces and count vehicles within an area. The battery-powered vehicle- detection device communicates with a parking or traffic management system using a wireless protocol. The battery-powered vehicle-detection device typically receives its power from one or more small, long-lasting batteries.

FIG. 1 depicts a prior-art battery-powered wireless vehicle-detection device 100, as described in US Patent Publication No. 2019/0311622 (“Low-profile Surface-mounted Wireless Parking Sensor” by Birchenko). The vehicle-detection device body 150 houses and supports a circular-shaped PCB 120 and one or more batteries 130. The vehicle-detection device base 160 supports the vehicle-detection device body 150. A central, vertical pillar 110 connects to the vehicle-detection device base 160 and is capable of supporting the weight of a motor vehicle. The rubber O-ring 140 provides a hermetic seal to prevent moisture from entering the device. The circular PCB 120 includes electronics for motor vehicle sensing and wireless communication (e.g., Bluetooth, LoRaWAN, etc.) The batteries 130 are disposed around the outside of the circular PCB 120 at approximately the same vertical elevation to minimize the height of the vehicle-detection device 100.

US Patent Publication No. 2020/0053563 (“System and Method for Fast, Secure and Power Efficient Occupancy Session Management” by Birchenko) describes electronic devices for motor vehicle sensing. The vehicle-detection capabilities include a magnetometer to detect ferrous metals, an IR sensor to detect reflected LED pulses, an active ultrasonic sensor based on time-of-flight principle, a vibration sensor, and other sensors.

As the automotive industry transitions from gasoline-powered vehicles to electric vehicles, the vehicles contain less ferrous metals. Consequently, the magnetometer becomes less accurate as a vehicle sensor, as the magnetometer may not detect the small quantity of ferrous metals in the vehicle. Further, pollution, snow, ice, and/or water can change the reflective properties of the vehicle bottom and road surface. Such conditions can therefore interfere with the operation of devices that use sensors that detect light or electromagnetic waves.

In light of the above, more effective sensing techniques would be useful.

### SUMMARY

Various embodiments set forth a device comprising a battery that generates a first power, and an inductive sensor that generates a magnetic field based on the first power, and generates, based on a change to the magnetic field, a sensing signal indicating a presence of an object, where delivery of the first power to the inductive sensor is based on one or more additional signals.

Other embodiments of the present disclosure set forth a method comprising receiving, by an inductive sensor, a first power generated by a battery, where the first power is provided to the inductive sensor based on one or more additional signals, generating, by the inductive sensor and based on the first power, a magnetic field, generating, based on a change to the magnetic field, a sensing signal indicating a presence of an object.

At least one technological advantage of the battery-powered vehicle-detection device with induction sensor relative to the prior art is that, with the disclosed apparatus, a device can periodically power an induction sensor to sense nearby objects based on an initial detection from passive sensors, lowering the amount of energy used that the apparatus uses. Further, as the battery-powered vehicle-detection device with induction sensor detects objects based on changes in a magnetic field, the device can detect a wider range of vehicles that contain fewer quantities of ferrous materials or have higher road clearances. These technical advantages provide one or more technological advancements over prior art approaches.

### BRIEF DESCRIPTION OF THE DRAWINGS

So that the manner in which the above-recited features of the various embodiments can be understood in detail, a more-particular description of the inventive concepts, briefly summarized above, can be had by reference to the various embodiments, some of which are illustrated in the appended drawings. The accompanying drawings, which are incorporated in and form a part of this specification and in which like numerals depict like elements, illustrate embodiments of the present disclosure and, together with the description, serve to explain the principles of the disclosure. It is to be noted, however, that the accompanying drawings illustrate only typical embodiments of the inventive concepts and are therefore not to be considered limiting in scope in any way, and that there are other equally-effective embodiments.

FIG. 1 depicts an example prior-art battery-powered, wireless vehicle-detection device.

FIG. 2 illustrates an example object detection system including a battery-powered vehicle-detection device with induction sensor (BVDI), according to one or more embodiments.

FIG. 3 illustrates a top view of an example printed circuit board (PCB) included in the BVDI of FIG. 2, according to one or more embodiments.

FIG. 4 is a conceptual diagram depicting connectivity of printed circuit board components included in the BVDI of FIG. 2, according to one or more embodiments.

FIG. 5 illustrates an example device 500 included a set of batteries embedded within cut-out areas of the printed circuit board included in the vehicle-detection device of FIG. 2, according to one or more embodiments.

FIG. 6 sets forth a flow chart of method steps for controlling one or more sensors for the vehicle-detective device of FIG. 2 to detect an object, according to one or more embodiments.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail so as not to unnecessarily obscure aspects and features of the subject matter.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “displaying,” “writing,” “including,” “storing,” “transmitting,” “traversing,” “determining,” “identifying,” “observing,” “adjusting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### OVERVIEW

An inductive sensor uses electromagnetic induction to detect or measure objects. An inductor develops a magnetic field when a current flows through the inductor. When the induced magnetic field is present, an external conductive object that is placed in proximity to the inductor changes the magnetic field created by the inductor, and, hence, changes the measured inductance (e.g., the ratio between the magnetic field flux and the current). Inductive sensors work well within harsh environments, as these types of sensors are robust to environmental factors when compared to other types of sensors and can deliver stable signals even in hostile environments. Many entities use various types of inductive sensors to monitor traffic by embedding large inductance loops (or coils) of wire in the road surface. In such instances, the inductance loop can be connected to an alternating-current (AC) power supply to create the inductive sensor. When a vehicle approaches the inductance loop, the inductance of the loop changes due to the presence of conductive vehicle components in the induced magnetic field. A sensor circuit coupled to the inductance loop measures or detects that change of inductance and transmits sensor data that indicates the presence of a vehicle.

One of the drawbacks of conventional object detection sensors is that the sensing range of a given inductive sensor is dependent on the coil diameter of the inductance loop. As a result, some coil diameters used in inductive sensors can be larger than the size of a typical battery-powered vehicle-detection device. Further, the detection sensitivity of inductive sensors can decline rapidly when detecting objects that are at distances beyond the diameter of the inductive coil. In addition, some battery-powered vehicle-detection devices have batteries that provide limited power, as a direct current (DC). By contrast, various inductive sensors operate with a high-power input and an alternating current (AC).

In view of the foregoing, various embodiments of the present disclosure include devices having induction loops and/or inductive sensors embedded within a battery-powered vehicle-detection device. The battery-powered vehicle-detection device with an inductive sensor (BVDI) employs an inductive coil located around and/or close to an outer perimeter of a circular printed circuit board (PCB). The detection range of the BVDI is proportional to the diameter of a loop. In various embodiments, the BVDI can include a maximized coil diameter that is within the physical constraints imposed by the overall physical size of the BVDI device. In various embodiments, the BVDI controls power that the battery provides to the inductive sensor. Controlling the operation of the inductive sensors in this manner conserves power by operating the inductive sensor for short periods of time, while using separate low-power sensors over longer periods. In some embodiments, the BVDI can include a wide-range 28-bit analog-to-digital (A/D) converter and an oscillator that generates an alternating current from the direct current provided by the battery. Additionally or alternatively, the A/D converter chip can obtain an accurate inductance measurement from the inductive loop when detecting objects at distances beyond two inductive loop diameters. For example, a BVDI that includes an inductive coil having a 4″ diameter and a wide-range A/D converter chip can generate an inductance measurement that detects a truck with a clearance of 15″ or at a position that is 15″ away from the inductive coil, in one or more embodiments.

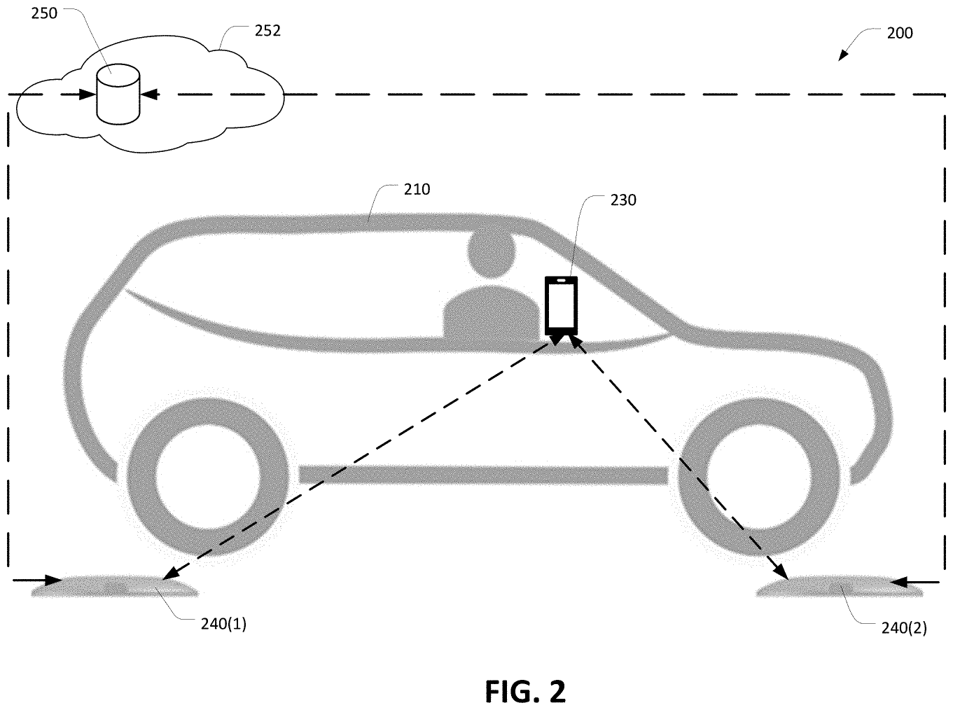

FIG. 2 illustrates an example object detection system 200 including a battery-powered vehicle-detection device with induction sensor (BVDI) 240, according to one or more embodiments. As shown, and without limitation, the object detection system 200 includes a vehicle 210, a communication device 230, one or more BVDIs 240, a network 252, and a remote management server 250.

In operation, the one or more BVDIs 240 use one or more induction sensors to sense the presence of the vehicle 210. The BVDIs generate sensing signals that indicate the presence of the vehicle 210 and wirelessly transmit the sensing signals to the communication device 230 and/or the remote management server 250.

The vehicle 210 can be various types of motor vehicles, such as cars, sports-utility vehicles, vans, trucks, buses, etc. In some embodiments, the vehicle 210 can have a clearance height that is larger than a diameter of the inductive coil included in the inductive sensor. In various embodiments, the vehicle 210 can contain a communication device 230, such as a smart-phone or an embedded computer.

In some embodiments, the one or more BVDIs 240 detect the vehicle 210 and respond to the detection by transmitting the sensing signal to the communication device 230. In such instances, the sensing signal indicates that the one or more BVDIs 240 detected the vehicle 210. In some embodiments, the one or more BVDIs 240 can generate a detection signal based on the sensing signal. For example, the BVDIs 240 could compare the sensing signal to a threshold and generate a binary detection signal that indicates the presence or absence of an object. In such instances, the BVDIs 240 could transmit the detection signal in conjunction with or in lieu of transmitting the sensing signal. Additionally or alternatively, other possible systems can employ or integrate with the BVDI devices 240. For example, various object detecting systems, such as vehicle counting systems, automatic gate control systems, security systems, transportation safety systems (e.g., locomotive safety systems), can include one or more BVDI devices 240 to detect objects within a specific area.

Additionally or alternatively, in various embodiments, the BVDIs can wirelessly transmit the sensing signal using one or more communication protocols (e.g., Bluetooth, WiFi, LTE, etc.). In various embodiments, the BVDI devices 240 can have long-range wireless communication capabilities. For example, the BVDI can include one or more radio transmitters that communicate with the remote management server 250.

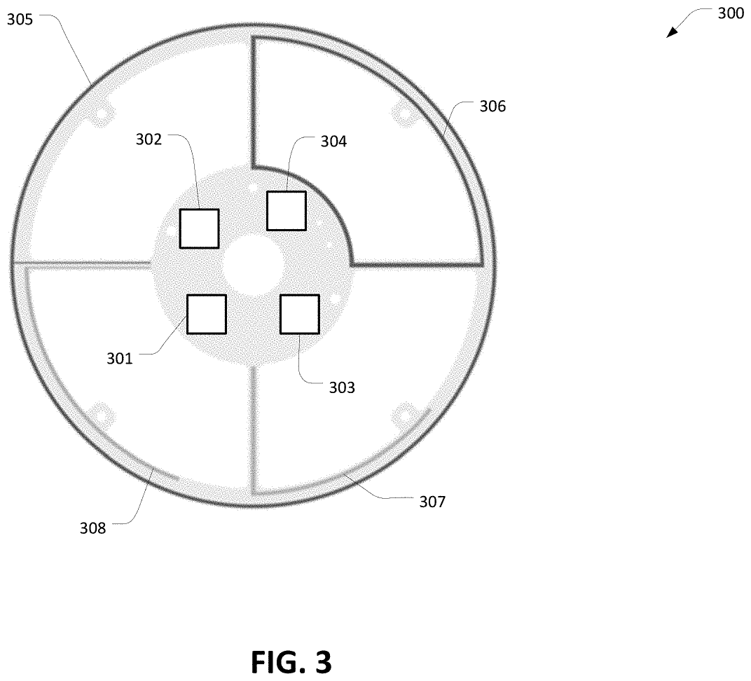

FIG. 3 illustrates a top view of an example printed circuit board (PCB) 300 included in the BVDI 240 of FIG. 2, according to one or more embodiments. As shown, and without limitation, the PCB 300 includes a microprocessor 301, a magnetometer 302, an ambient light sensor 303, an inductance management and digital converter unit (IMDCU) 304, a first inductance coil 305, a second inductance coil 306, and radio-frequency (RF) antennas 307-308.

The microprocessor 301 provides overall control of the BVDI 240. In various embodiments, the microprocessor 301 can orchestrate various sensing tasks and/or control RF communications. For example, the microprocessor 301 can calibrate each of the sensors 302, 303, 305, 306, can determine whether the sensing signals generated by the sensors 302, 303, 305, 306 indicate the presence of an object (e.g., a vehicle proximate to the BVDI 240), and/or can generate a detection signal that indicates the determination regarding the presence of the object. In another example, the microprocessor 301 can periodically enable one or more of the inductance coils 305-306 to perform periodic high-power object detection.

In various embodiments, the BVDI 240 can include one or more low-power sensors and one or more high-power inductive sensors. For example, as shown, the PCB 300 includes two passive, low-power sensors (e.g., the magnetometer 302 and the ambient light sensor 303) and two high-power inductive sensors (e.g., 305-306). The magnetometer 302 detects the presence of ferrous metals. For example, vehicles that include ferrous materials (e.g., the vehicle 210) can be detected by the magnetometer 302. In such instances, the magnetometer 302 can act as a passive, low-power sensor that the BVDI 240 can use for initial detection of vehicles. The ambient light sensor 303 detects variations in an ambient light level. In various embodiments, the ambient light sensor 303 can be a passive, low-power sensor that can be used for initial detection of vehicles in concert with or in lieu of the magnetometer 302. In various embodiments, the passive sensor data can be sampled with a given frequency (e.g., ˜1 Hz) to detect changes indicating an increased probability of vehicle presence. In such instances, when the estimated probability function is above a certain threshold, the control processor can turn on inductive sensing.

The inductance management and digital converter unit (IMDCU) 304 controls the power input to the inductive sensors. In various embodiments, the IMDCU 304 can include an oscillator that converts a DC battery current to an AC current for the inductive coils 305-306. In some embodiments, the IMDCU 304 can include one or more modules that measure one or more inductive currents produced by the inductance coils 305-306. In some embodiments, the microprocessor 301 can employ the inductance measurement of the inductance coils 305-306 as the sensing signal. Alternatively, in some embodiments, the microprocessor 301 can use the inductance measurements as an input when generating the sensing signal and/or the detection signal. In one example, the microprocessor 301 can compare the inductance measurements to one or more thresholds. The microprocessor 301 can then generate a sensing signal based on a determination of whether either or both of the inductance measurements exceeded an associated threshold. In another example, the microprocessor 301 can generate the detection signal as a binary signal based on a sensing signal that includes the inductance measurements.

The inductance coils 305-306 induce two magnetic fields. In various embodiments, the IMDCU 304 and/or the microprocessor 301 can generate inductance measurements that indicate changes in the induced magnetic fields generated by the inductance coils 305-306. In various embodiments, the inductance coils 305-306 can have different configurations. For example, the inductance coil 305 can have a different diameter or number of turns than the inductance coil 306. In the example of FIG. 3, the inductance coil 305 has multiple turns (e.g., 10 turns) around the outer rim of the PCB 300. Other configurations are possible; for example, the inductance coil 305 could have one turn. Following the example of FIG. 3, the second inductance coil 306 has a smaller effective diameter relative to the inductance coil 305. In such instances, the inductance coil 306 can have a comparatively more-limited sensitivity than the inductance coil 305 to detect vehicles on top. In such instances, the inductance coil 306 acts mainly as a reference for calibration purposes and/or help offset environment changes to inductance (e.g., temperature, humidity, etc.). In the example of FIG. 3, the inductance coil 305 has a larger effective diameter. In such instances, the inductance coil 305 can detect vehicles at a range above 5 inches. In various embodiments, second inductance coil 306 could have different numbers of turns. In the example of FIG. 3, the inductance coil 306 is located around a quadrant of the PCB 300.

The RF antennas 307-308 can be transceivers for various frequencies to communicate with other devices using one or more communication protocols. For example, the RF antenna 307 can be a Bluetooth antenna for short to medium distance communication, while the RF antenna 308 can serve as an antenna for long-distance communication (e.g., communications at sub-GHz wavelengths).

Different embodiments of the PCB 300 and/or the BVDI 240 could have different configurations, such as one or more inductive sensors, one or more passive low-power sensors, and different types of low-power sensors. Some embodiments of the BVDI 240 could use many combinations of sensors with or without an inductive sensor. Sensor examples include radar and passive light detection sensors.

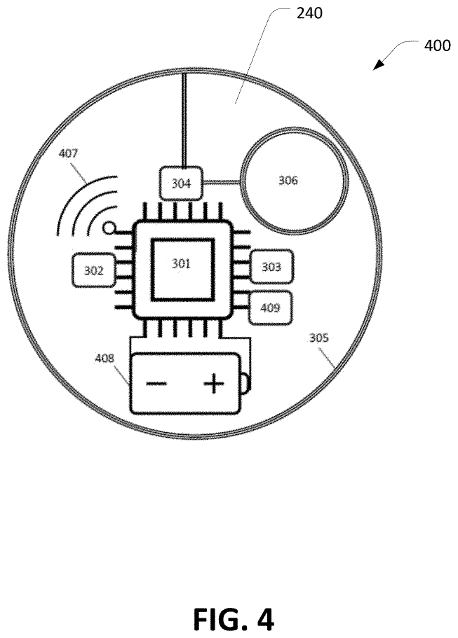

FIG. 4 is a conceptual diagram 400 depicting connectivity of example printed circuit board components included in the BVDI 240 of FIG. 2, according to one or more embodiments. As shown, and without limitation, the BVDI 240 includes the microprocessor 301, the magnetometer 302, the ambient light sensor 303, the first inductance coil 305, the second inductance coil 306, a radio transmission system 407, a battery 408, and memory 409.

In various embodiments, the microprocessor 301 can be coupled to the memory 409, the magnetometer 302, the ambient light sensor 303, the IMDCU 304, the radio transmission system 407, and/or the battery 408. In some embodiments, the memory 409 and microprocessor 301 can be integrated within the same silicon device or within the same semiconductor package.

The microprocessor 301 reads from and/or writes to the memory 409. The memory 409 holds one or more executable instructions that the microprocessor 301 executes to enable various functionalities of the BVDI 240. In some embodiments, the memory 409 can store status information; in such instances, the status information can be updated by the microprocessor 301.

The microprocessor 301 controls the magnetometer 302, and/or the ambient light sensor 303 by initiating their operation and by reading vehicle-detection measurements (e.g., electrical and/or optical sensor data) acquired by the magnetometer 302 and/or the ambient light sensor 303. In various embodiments, the microprocessor 301 can control the IMDCU 304 by enabling the one or more inductive sensors at specific times and by causing the IMDCU 304 to take inductance measurements from the inductive sensors. Additionally or alternatively, in some embodiments, the microprocessor 301 can control the radio transmission system 407 to send and/or receive messages over various communications channels (e.g., via Bluetooth and/or long-distance radio communications channels). The battery 408 supplies power (e.g., a direct current at a specific voltage) to the PCB and all components.

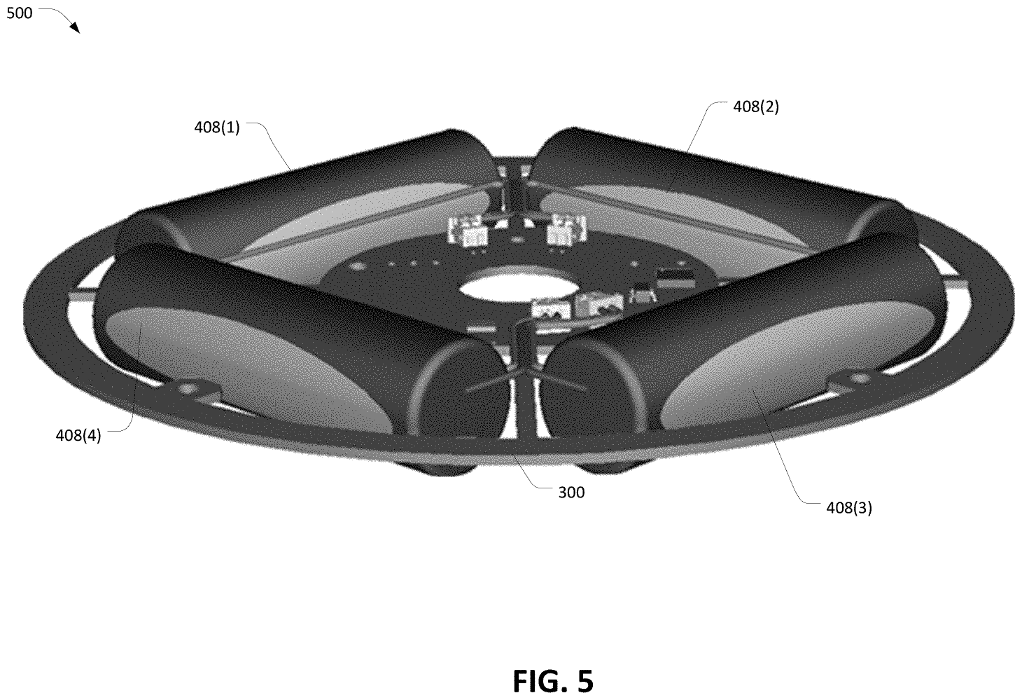

FIG. 5 illustrates a device 500 including a set of batteries 408 embedded within cut-out areas of the printed circuit board 300 included in the BVDI 240 of FIG. 2, according to one or more embodiments. As shown, the device 500 includes the PCB 300 and the set of batteries 408.

As shown, in some embodiments, the set of batteries 408 may be disposed on a common plane with the PCB 300. In such instances, positioning the set of batteries 408 on the same plane of the PCB 300 can minimize the height of the BVDI 240. In some embodiments, the set of batteries 408 can be disposed within the outer perimeter of the PCB 300. In such instances, disposing the set of batteries 408 inside the PCB 300 maximizes the diameter of the first inductance coil 305 and/or optimizes the diameter of the overall device 500.

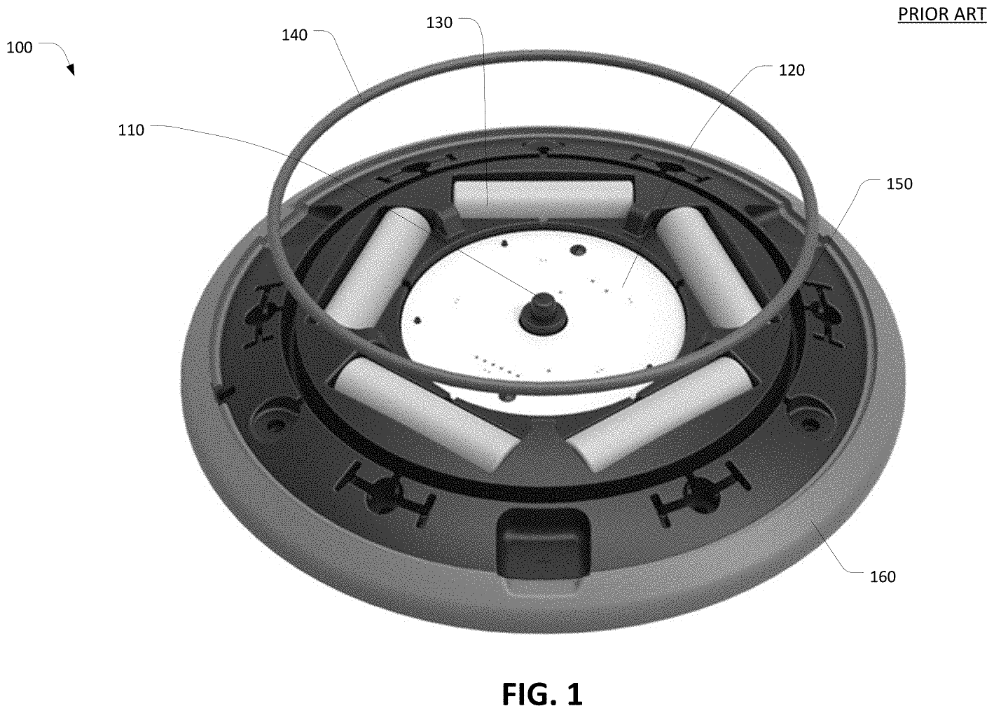

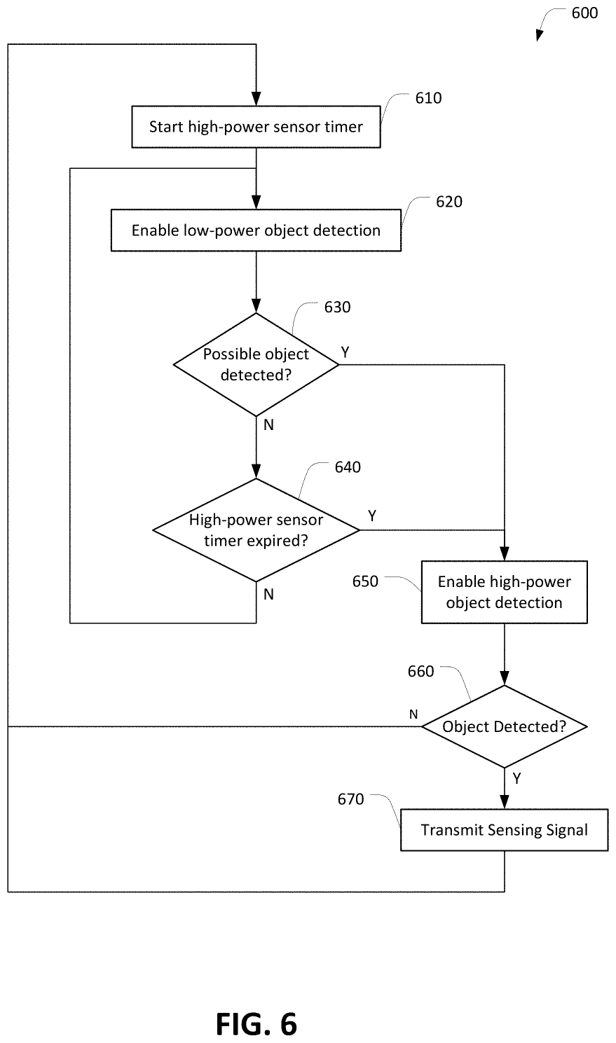

FIG. 6 sets forth a flow of method steps for controlling high-power sensors, according to one or more embodiments. Although the method steps are described with respect to FIGS. 1-5, persons skilled in the art will understand that any system configured to perform the method steps, in any order, falls within the scope of the various embodiments.

As shown, the method 600 beings at step 610, where the BVDI 240 starts a high-power sensor timer. At step 620, the BVDI 240 enables low-power object detection. For example, the BVDI 240 can enable a low-power detection mode where one or more passive, low-power sensors (e.g., the magnetometer 302 and/or the ambient light sensor 303) can acquire sensor data. In various embodiments, the passive, low-power sensors can operate persistently; alternatively, the passive, low-power sensors can use separate, shorter duration timers.

At step 630, the BVDI 240 determines whether an object has been detected. In various embodiments, the microprocessor 301 can determine whether any of the passive, low-power sensors detected a possible object (e.g., the vehicle 210). For example, the microprocessor 301 can acquire vehicle-detection measurements (e.g., electrical and/or optical sensor data) acquired by the magnetometer 302 and/or the ambient light sensor 303 and compare the acquired vehicle-detection measurements to one or more pre-defined thresholds. When the BVDI 240 determines that one or more of the passive, low-power sensors have detected a possible object, the microprocessor 301 determines a high-probability that an object is present and proceeds to step 650. Otherwise, when the BVDI 240 determines a low probability that the one or more passive, low-power sensors detected a possible object, the BVDI 240 continues to step 640.

At step 640, the BVDI 240 determines whether the timer has expired. In various embodiments, the BVDI 240 can periodically perform high-power object detection. In such instances, the microprocessor 301 can cause the IMDCU 304 to provide AC power to the high-power inductance sensors when the timer expires. When the BVDI 240 determines that the timer has expired, the BVDI 240 proceeds to step 650. Otherwise, when the BVDI 240 determines that the timer has not expired, the BVDI 240 returns to step 610.

At step 650, the BVDI 240 enables the high-power object detection. In various embodiments, the microprocessor 301 can enable the high-power object detection by causing the IMDCU 304 to provide AC power to the first inductance coil 305 and/or the second inductance coil 306. In such instances, the inductance sensor can use the magnetic fields induced by the first inductance coil 305 and/or the second inductance coil 306 to take object-detection measurements. In some embodiments, the BVDI 240 can enable the high-power inductive sensors separately, one after another.

At step 660, the BVDI 240 determines whether an object has been detected. In various embodiments, the microprocessor 301 can cause the IMDCU 304 to acquire measurements regarding the induced magnetic fields from the first induction coil 305 and/or the second induction coil 306. The microprocessor 301 can then compare the measurements with a pre-defined threshold. In some embodiments, the microprocessor 301 can generate a sensing signal and/or a determination signal that indicates the result of the comparison When the BVDI 240 determines that an object (e.d., the vehicle 210) has been detected, the BVDI 240 proceeds to step 670. Otherwise, the BVDI 240 determines that an object has not been detected and returns to step 610.

At step 670, the BVDI 240 transmits a sensing signal. In various embodiments, the microprocessor 301 can transmit a sensing signal to one or more devices via the radio transmission system 407. For example, the BVDI 240 can transmit the sensing signal over a Bluetooth communication channel to the communication device 230, where the sensing signal indicates that the BVDI 240 detected the presence of the vehicle 210. In another example, the BVDI 240 can transmit the sensing signal over a long-distance radio communication channel to the remote management server 250. In some embodiments, the BVDI 240 can generate a determination signal based on the sensing signal. In such instances, the BVDI 240 can transmit the determination signal in conjunction with or in lieu of the sensing signal. Upon transmitting the sensing signal, the BVDI 240 can return to step 610.

In some embodiments, The BVDI 240 can be configured so that each high-power inductive sensor is associated with a different timer that has a different duration. In such instances, the BVDI 240 can execute the method 600 on each of the respective high-power inductive sensors in parallel. For example, the BVDI 240 can execute step 640 to enable high-power object detection using the specific high-power inductive sensor that is associated with the specific timer that expired.

In various embodiments, the BVDI 240 can be configured to apply different power modes to detect the presence and/or the absence of the vehicle 210. For example, the vehicle 210 can be parked close to the BVDI 240 for many hours. In such instances, measurements from sensor data acquired by the magnetometer 302 and/or the ambient light sensor 303 can confirm that the vehicle 210 remains present. Accordingly, the BVDI 240 can refrain from powering the inductive sensor and reading inductance measurements.

In some embodiments, in order to keep track of a baseline level (e.g., when no object present) of the various magnetic fields and/or other measurements, and/or to adjust for gradual changes (e.g., changes due to temperature drifts, precipitation, etc.), the BVDI 240 can power the inductive sensors for brief periods to perform measurements. For example, the BVDI 240 can power the inductive sensors for 25 milliseconds approximately every minute. In such instances, the BVDI 240 can control the inductive sensors using a form of duty cycle modulation. The inductive sensors may be susceptible to common thermal drifts or other near-range changes (e.g., less than one coil diameter). In some embodiments, the high-power inductive sensor timer duration can vary, for example, based on onboard temperature sensor measurements.

In some embodiments, various larger inductance coil sensors can have a proportionally longer sensing range and can be more responsive to environment changes beyond one diameter, compared to the characteristics of a smaller inductance coil. In various embodiments, the microprocessor 301 can apply various statistical regression algorithms to time-series data generated by the one or more inductive sensors in order to detect a sensing signal induced by objects that are located beyond one diameter of a given inductance coil.

1. In various embodiments, a device comprises a battery that generates a first power, and an inductive sensor that generates a magnetic field based on the first power, and generates, based on a change to the magnetic field, a sensing signal indicating a presence of an object, where delivery of the first power to the inductive sensor is based on one or more additional signals.

2. The device of clause 1, further comprising a microprocessor that generates a determination based on the sensing signal and causes the determination to be wirelessly transmitted to at least one remote device.

3. The device of clause 1 or 2, further comprising a printed circuit board, where the microprocessor is mounted on the printed circuit board, and the batteries are disposed within one or more cut-out areas included in the printed circuit board.

4. The device of any of clauses 1-3, further comprising at least one passive sensor that generates the one or more additional signals, and a microprocessor that receives the one or more additional signals from the at least one passive sensor, and controls, based on the one or more additional signals, the first power to the inductive sensor.

5. The device of any of clauses 1-4, where the least one passive sensor comprises at least one of a light sensor that measures ambient light, a magnetometer that measures a quantity of ferrous materials, or a temperature sensor.

6. The device of any of clauses 1-5, further comprising a microprocessor that controls delivery of the first power to the inductive sensor by determining that the one or more additional signals indicate a likelihood that a vehicle is proximate to at least one passive sensor, where the at least one passive sensor generates the one or more additional signals, and in response, to the determination, causing the battery to provide the first power to the inductive sensor.

7. The device of any of clauses 1-6, where the inductive sensor comprises a loop coil that includes at least one turn.

8. The device of any of clauses 1-7, where the inductive sensor further comprises an oscillator that (i) converts the first power into a first alternating current (AC) power, and (ii) provides the first AC power to the loop coil, and an analog-to-digital (A/D) converter that (i) receives the sensing signal from the loop coil, and (ii) converts the sensing signal into a digital sensing signal .

9. The device of any of clauses 1-8, further comprising an enclosure that includes the loop coil, where the loop coil: (i) is located proximate to an outer perimeter of the enclosure, or (ii) has an effective diameter of at least 4 cm.

10. The device of any of clauses 1-9, further comprising a timer that generates a timing signal indicating when a first period ends, and a microprocessor that receives the timing signal, and causes the battery to provide a first power to the inductive sensor based on (i) the timing signal, or (ii) the one or more additional signals.

11. The device of any of clauses 1-10 further comprising a second inductive sensor, where the inductive sensor includes a first loop coil having a first loop size and one or more turns, and the second inductive sensor includes a second loop coil having a second loop size and one or more turns.

12. The device of any of clauses 1-11, where a first sensing range of the first loop coil to detect the presence of the object is based on the first loop size, and a second sensing range of the second loop coil to detect the presence of the object is based on the second loop size.

13. The device of any of clauses 1-12, where the first sensing range is at least 12 cm.

14. In various embodiments, a method comprises receiving, by an inductive sensor, a first power generated by a battery, where the first power is provided to the inductive sensor based on one or more additional signals, generating, by the inductive sensor and based on the first power, a magnetic field, generating, based on a change to the magnetic field, a sensing signal indicating a presence of an object.

15. The method of clause 14, further comprising receiving, by a microprocessor, the one or more additional signals that are provided by at least one passive sensor, and providing, based on the one or more additional signals, the first power to the inductive sensor.

16. The method of clause 14 or 15, further comprising determining, based on the one or more additional signals, a probability that the object is present, upon determining the probability, providing the first power to the inductive sensor, where the inductive sensor provides the sensing signal.

17. The method of any of clauses 14-16, further comprising receiving a timing signal indicating when a first period ends, and causes the battery to provide the first power to the inductive sensor based on (i) the timing signal, or (ii) the one or more additional signals.

18. The method of any of clauses 14-17, further comprising converting the first power into a first alternating current (AC) power, providing the first AC power to a loop coil that generates the magnetic field, receiving, by an analog-to-digital converter, the sensing signal from loop coil, and converting, by the analog-to-digital converter, the sensing signal to a digital sensing signal.

19. The method of any of clauses 14-18, further comprising generating a determination signal based on the sensing signal, and wirelessly transmitting the determination signal to at least one remote device.

20. The method of any of clauses 14-19, where the remote device comprises at least one of a portable device, a vehicle counting system, an automatic gate control system, or a remote server.

Any and all combinations of any of the claim elements recited in any of the claims and/or any elements described in this application, in any fashion, fall within the contemplated scope of the present invention and protection.

All examples and conditional language recited herein are intended for pedagogical purposes to aid the reader in understanding the principles of the present disclosure and the concepts contributed by the inventor to furthering the art and are to be construed as being without limitation to such specifically recited examples and conditions. Moreover, all statements herein reciting principles, aspects, and embodiments of the present disclosure, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing descriptions of various specific embodiments in accordance with the present disclosure have been presented for purposes of illustration and description. They are not intended to be exhaustive or to limit the present disclosure to the precise forms disclosed, and many modifications and variations are possible in light of the above teaching. The present disclosure is to be construed according to the claims that follow and their equivalents.

What is claimed is:

1. A device comprising:
a battery that generates a first power; and
an inductive sensor that:
generates a magnetic field based on the first power, and
generates, based on a change to the magnetic field, a sensing signal indicating a presence of an object,
wherein delivery of the first power to the inductive sensor is based on one or more additional signals.

2. The device of claim 1, further comprising a microprocessor that:
generates a determination based on the sensing signal; and
causes the determination to be wirelessly transmitted to at least one remote device.

3. The device of claim 2, further comprising a printed circuit board, wherein:
the microprocessor is mounted on the printed circuit board; and
the batteries are disposed within one or more cut-out areas included in the printed circuit board.

4. The device of claim 1, further comprising:
at least one passive sensor that generates the one or more additional signals; and
a microprocessor that:
receives the one or more additional signals from the at least one passive sensor; and
controls, based on the one or more additional signals, the first power to the inductive sensor.

5. The device of claim 4, wherein the least one passive sensor comprises at least one of:
a light sensor that measures ambient light,
a magnetometer that measures a quantity of ferrous materials, or
a temperature sensor.

6. The device of claim 1, further comprising a microprocessor that controls delivery of the first power to the inductive sensor by:
determining that the one or more additional signals indicate a likelihood that a vehicle is proximate to at least one passive sensor, wherein the at least one passive sensor generates the one or more additional signals; and
in response, to the determination, causing the battery to provide the first power to the inductive sensor.

7. The device of claim 1, wherein the inductive sensor comprises a loop coil that includes at least one turn.

8. The device of claim 7, wherein the inductive sensor further comprises:
an oscillator that (i) converts the first power into a first alternating current (AC) power, and (ii) provides the first AC power to the loop coil; and
an analog-to-digital (A/D) converter that (i) receives the sensing signal from the loop coil, and (ii) converts the sensing signal into a digital sensing signal .

9. The device of claim 7, further comprising an enclosure that includes the loop coil, wherein the loop coil: (i) is located proximate to an outer perimeter of the enclosure, or (ii) has an effective diameter of at least 4 cm.

10. The device of claim 1, further comprising:
a timer that generates a timing signal indicating when a first period ends; and
a microprocessor that:
receives the timing signal; and
causes the battery to provide a first power to the inductive sensor based on (i) the timing signal, or (ii) the one or more additional signals.

11. The device of claim 1, further comprising a second inductive sensor, wherein:
the inductive sensor includes a first loop coil having a first loop size and one or more turns; and
the second inductive sensor includes a second loop coil having a second loop size and one or more turns.

12. The device of claim 11, wherein:
a first sensing range of the first loop coil to detect the presence of the object is based on the first loop size; and
a second sensing range of the second loop coil to detect the presence of the object is based on the second loop size.

13. The device of claim 12, wherein the first sensing range is at least 12 cm.

14. A method comprising:
receiving, by an inductive sensor, a first power generated by a battery, wherein the first power is provided to the inductive sensor based on one or more additional signals;
generating, by the inductive sensor and based on the first power, a magnetic field;
generating, based on a change to the magnetic field, a sensing signal indicating a presence of an object.

15. The method of claim 14, further comprising:
receiving, by a microprocessor, the one or more additional signals that are provided by at least one passive sensor; and
providing, based on the one or more additional signals, the first power to the inductive sensor.

16. The method of claim 14, further comprising:
determining, based on the one or more additional signals, a probability that the object is present;
upon determining the probability, providing the first power to the inductive sensor, wherein the inductive sensor provides the sensing signal.

17. The method of claim 14, further comprising:
receiving a timing signal indicating when a first period ends; and
causes the battery to provide the first power to the inductive sensor based on (i) the timing signal, or (ii) the one or more additional signals.

18. The method of claim 14, further comprising:
converting the first power into a first alternating current (AC) power;
providing the first AC power to a loop coil that generates the magnetic field;
receiving, by an analog-to-digital converter, the sensing signal from loop coil; and
converting, by the analog-to-digital converter, the sensing signal to a digital sensing signal.

19. The method of claim 14, further comprising:
generating a determination signal based on the sensing signal; and
wirelessly transmitting the determination signal to at least one remote device.

20. The method of claim 19, wherein the remote device comprises at least one of a portable device, a vehicle counting system, an automatic gate control system, or a remote server.
